(19) United States
(12) Patent Application Publication
(10) Pub. No.: US 2019/0203698 A1
(43) Pub. Date: Jul. 4, 2019

(54) METHOD AND DEVICE FOR DETERMINING LOADS ON A WIND TURBINE TOWER

(71) Applicant: fos4X GmbH, München (DE)

(72) Inventors: Mathias Müller, Gröbenzell (DE); Christian Sievers, München (DE); Thomas Schauß, Gilching (DE)

(21) Appl. No.: 16/333,048

(22) PCT Filed: Sep. 11, 2017
(86) PCT No.: PCT/EP2017/072751

§ 371 Date: Mar. 13, 2019

(30) Foreign Application Priority Data
Sep. 13, 2016 (DE) 10 2016 117 191.3

(51) Int. Cl. F03D 17/00; G01P 5/02; G01L 1/04

(52) U.S. Cl. CPC F03D 17/00; F03D 1/00; G01L 1/04; G01P 5/02

(57) ABSTRACT

The invention relates to a method (100) for determining loads on a wind turbine tower. In a first step (110) of the method (100), bending moments in at least one rotor blade of the wind turbine are determined in order to provide a first variable, which identifies a first force acting on a nacelle of the wind turbine tower. In addition, in a second step (120) of the method (100), a nacelle deflection is determined in order to provide a second variable which identifies a second force acting on the nacelle of the wind turbine tower. Furthermore, a third step (130) of the method (100) comprises entering the first variable and the second variable into a calculation model, which displays the behavior of the tower. A fourth step (140) of the method (100) comprises a determination of loads on the tower of the wind turbine by means of the calculation model.

### TECHNICAL FIELD

The present invention relates in general to monitoring the operation of wind turbines—in particular, monitoring the state of a wind turbine tower. The invention relates, in particular, to an arrangement with fiber optic sensors for determining loads on a wind turbine tower.

### STATE OF THE ART

Systems for monitoring wind turbines that assess the condition are gaining in importance. The condition of a wind turbine tower, e.g., wear, material fatigue, and other changes which can occur due to aging or use, is the subject matter of the condition monitoring of wind turbines. With a knowledge of this condition, maintenance work can be planned, the present value of the installation estimated, and the safety requirements of the legislator and customer met.

In existing systems, the wind turbine tower is designed with regard to expected loads, such as gravitational load cycles caused by the number of rotor rotations or loads due to wind gusts, which are to be expected over the service life of the wind turbine. After installation of the wind turbine, the condition of the wind turbine tower is checked, for example, by means of regular inspections. This condition monitoring of the tower is, however, fraught with some degree of uncertainty, since, with short-term heavy loads, e.g., strong gusts of wind during thunderstorms, critical material loads can occur which may possibly lead to material failure shortly thereafter.

There is therefore a need for improved monitoring of the condition of a wind turbine tower.

### SUMMARY OF THE DISCLOSURE

Embodiments of the present disclosure provide a method for determining loads on a wind turbine tower according to claim 1. Furthermore, embodiments of the present disclosure provide a device adapted for the determination of loads on a wind turbine tower according to claim 10.

According to one embodiment, a method for determining loads on a wind turbine tower is provided. The method comprises: determining bending moments in at least one rotor blade of the wind turbine in order to provide a first variable, which identifies a first force acting on a nacelle of the wind turbine tower; determining a nacelle deflection in order to provide a second variable, which identifies a second force that acts on the nacelle of the wind turbine tower; entering the first variable and the second variable into a calculation model, which displays the behavior of the tower; and determining the loads on the wind turbine tower by means of the calculation model.

According to a further embodiment, a device adapted for determining loads on a wind turbine tower is provided. The device comprises: at least one strain sensor arranged and adapted for measuring a strain on at least one rotor blade of the wind turbine; at least one position sensor device arranged and adapted for determining the position of a nacelle of the wind turbine tower; and an evaluation unit, which is connected to the at least one strain sensor for receiving a first signal from the at least one strain sensor and which is connected to the at least one position sensor device for receiving a second signal from the at least one position sensor device, wherein the evaluation unit is adapted to determine, from the first signal, bending moments in the at least one rotor blade of the wind turbine, in order to provide a first variable, wherein the evaluation unit is adapted to determine, from the second signal, a nacelle deflection, in order to provide a second variable, and wherein the evaluation unit is adapted to determine loads on the wind turbine tower from the first variable and from the second variable by means of a calculation model that displays the behavior of the tower.

### BRIEF DESCRIPTION OF THE DRAWINGS

Exemplary embodiments are illustrated in the drawings and explained in greater detail in the following description. In the drawings is shown:

FIG. 1 a flow diagram of a method for determining loads on a wind turbine tower according to embodiments described herein;

FIG. 2 a flow diagram of a method for determining loads on a wind turbine tower according to further embodiments described herein;

FIG. 3 a simplified schematic illustration of a device according to embodiments described herein for determining loads on a wind turbine tower;

FIG. 4 a wind turbine, in order to explain embodiments described herein of a device for determining loads on a wind turbine tower; and

FIG. 5 a fiber optic sensor for determining bending moments in at least one rotor blade of the wind turbine in embodiments described herein.

### DESCRIPTION OF THE EMBODIMENTS

Embodiments of the present disclosure are explained below in more detail. The drawings serve to illustrate one or more examples of embodiments. In the drawings, the same reference numerals designate the same or similar features of the respective embodiments.

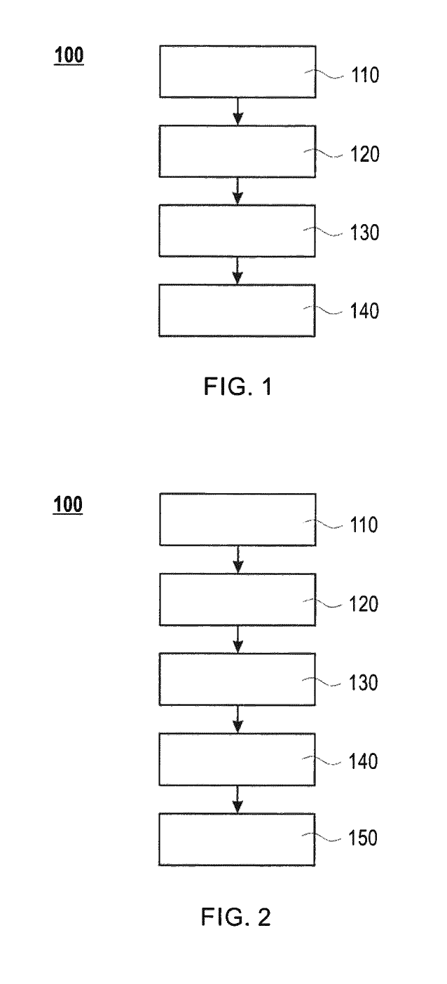

FIG. 1 is a flow diagram of a method 100 for determining loads on a wind turbine tower, in accordance with embodiments described herein. In a first step 100, the method 110 comprises determining bending moments in at least one rotor blade of the wind turbine, in order to provide a first variable. Typically, the first variable identifies a first force acting on a nacelle of the wind turbine tower. Furthermore, in a second step 100, the method 120 comprises determining a nacelle deflection, in order to provide a second variable. Typically, the second variable identifies a second force acting on the nacelle of the wind turbine tower. Furthermore, in a third step 100, the method 130 comprises entering the first variable and entering the second variable into a calculation model, which displays the behavior of the tower. A fourth step 140 of the method comprises determining loads on the wind turbine tower by means of the calculation model.

An improved condition monitoring of a wind turbine tower can thus be provided by means of the method described herein for determining loads on a wind turbine tower.

According to embodiments which may be combined with other embodiments described herein, the calculation model is a physical model of the wind turbine—in particular, of the wind turbine tower. Such a physical calculation model typically includes model parameters which, for example, take into account the dimensioning of the wind turbine—in particular, of the wind turbine tower—and also the material properties of the wind turbine—in particular, of the wind turbine tower. Furthermore, the physical calculation model can include dynamic model parameters that take into account, for example, material aging processes, load variations, weather conditions, or the like.

According to further embodiments which can be combined with other embodiments described herein, in the first step 110 of the method 100, during determination of the bending moments in the at least one rotor blade, a strain in the at least one rotor blade can be measured by means of at least one strain sensor, so that bending moments can be determined at least in one direction. According to other typical embodiments, at least two strain sensors—in particular, three strain sensors or at least four strain sensors—can be used to determine bending moments in a sectional plane of the at least one rotor blade of the wind turbine. With a suitable arrangement of two strain sensors, e.g., at different angular coordinates of the rotor blade root, the bending moments acting on the rotor blade can be measured in two directions—typically, in two orthogonal directions—even with two strain sensors. For this purpose, the two strain sensors should typically be mounted with angular coordinates rotated by 90°, or not with angular coordinates rotated by 180°.

Accordingly, according to embodiments of the method described herein, during determination of the bending moments in the at least one rotor blade, a strain in the at least one rotor blade can be measured in two—in particular, two mutually orthogonal—directions.

According to further embodiments which may be combined with other embodiments described herein, the at least one strain sensor is arranged in the at least one rotor blade. For example, the at least one strain sensor may be a fiber optic strain sensor, as described, by way of example, with reference to FIG. 5.

According to further embodiments which may be combined with other embodiments described herein, during determination of the nacelle deflection, a position determination of the nacelle may be performed by means of a position sensor device. Typically, the position sensor device is adapted to carry out at least one method selected from the group consisting of: a GPS position determination method—in particular, per RTK GPS (Real-Time Kinematic GPS); a differential GPS position determination method; a camera-based position determination method; a radar-based position determination method; and a laser-based position determination method. The position sensor device can be designed to use a stationary reference point for position determination. In the second step 120 of the method 100, a stationary reference point can thus be used when determining the nacelle deflection.

In this context, it should be noted that a differential GPS position determination method is to be understood as a method in which a GPS reference radio signal or a separate GPS reference station in the vicinity of the wind turbine is used.

As exemplified in the flow diagram shown in FIG. 2, in a fifth step 150, the method 100 may further include determining wind parameters—particularly, wind speed and/or wind direction—from the determined loads on the tower. Here, when determining the wind parameters, for example, the physical calculation model which displays the tower behavior can be used. In particular, by means of the determined loads on the wind turbine tower, on the basis of the physical calculation model, conclusions can be drawn regarding wind parameters, such as wind speed or wind direction.

In further embodiments which may be combined with other embodiments described herein, in the fourth step 140 of the method 100, when determining the loads on the tower by means of the calculation model, wind turbine parameters—in particular, tower thickness and/or tower material—may be used, so that an accurate load determination adapted to the wind turbine is made possible.

According to further embodiments which may be combined with other embodiments described herein, in the fourth step 140 of the method 100, when determining the loads on the tower by means of the calculation model, a Kalman filter may be used, in order to increase accuracy in determining the loads on the tower.

In this connection, it should be mentioned that, in contrast to the classic FIR and IIR filters of signal and time series analysis, the Kalman filter is based upon a state-space modeling in which a distinction is explicitly made between the dynamics of the system state and the process of its measurement. The use of a Kalman filter is therefore particularly advantageous in the method described herein, since its special mathematical structure allows use in real-time systems—for example, in the evaluation of signals for tracking the position of moving objects. Due to the real-time capability of the filter, the use of a Kalman filter when determining the loads on the tower by means of the calculation model—in particular, taking nacelle deflection into account—thus makes it possible to increase accuracy in determining the loads on the tower.

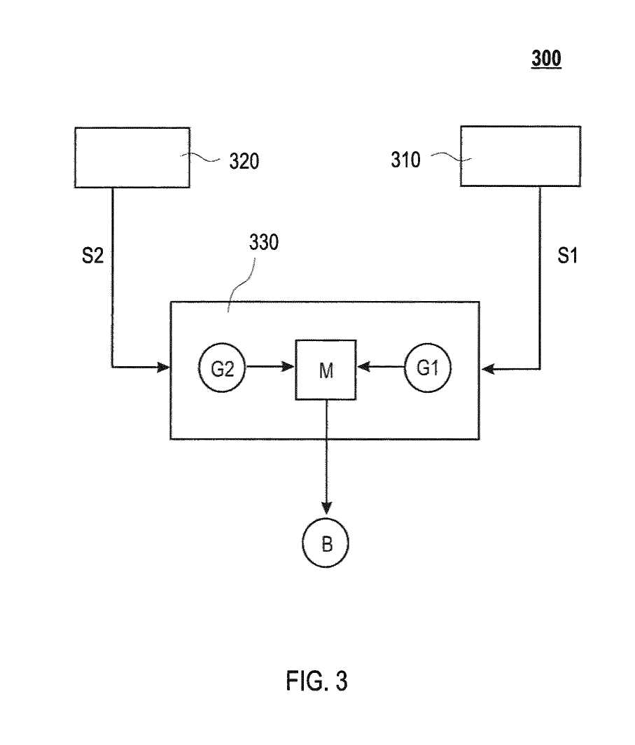

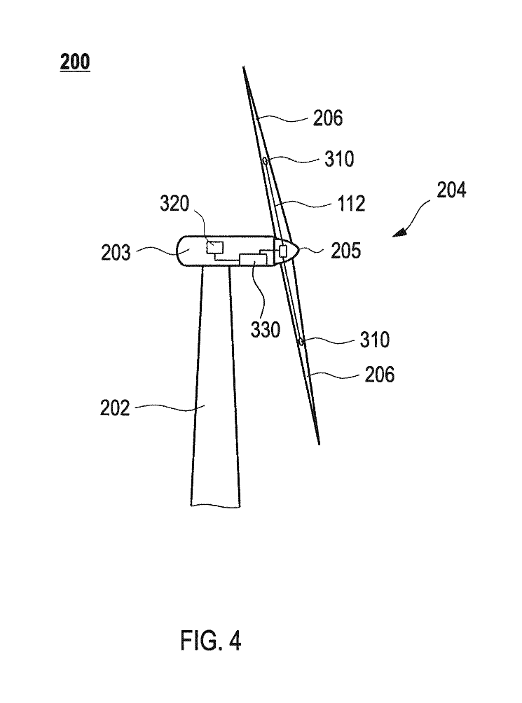

According to further embodiments which may be combined with other embodiments described herein, the method described herein may be applied—in particular, using a device as described herein—for determining loads on a wind turbine tower. FIG. 3 shows a simplified schematic diagram of a device 300 according to embodiments described herein for determining loads on a tower 202 of a wind turbine 200, as illustrated by way of example in FIG. 4.

According to embodiments described herein, the device 300 for determining loads on a tower 202 of a wind turbine 200 comprises at least one strain sensor 310, which is arranged on at least one rotor blade 210 of the wind turbine 200 and adapted so as to carry out a measurement of a strain on the at least one rotor blade of the wind turbine. Furthermore, the device 300 described herein includes at least one position sensor device 320, arranged on the wind turbine 200 and adapted so as to perform a position determination of the nacelle 203 of the tower 202 of the wind turbine 200. Furthermore, the device 300 described herein comprises an evaluation unit 330, connected to the at least one strain sensor 310 for receiving a first signal S1 from the at least one strain sensor 310 and connected to the at least one position sensor device 320 for receiving a second signal S2 from the at least one position sensor device 320.

Typically, the evaluation unit 330 is adapted to determine, from the first signal S1, bending moments in the at least one rotor blade of the wind turbine, in order to provide a first variable G1. Furthermore, the evaluation unit 330 is typically adapted to determine, from the second signal S2, a nacelle deflection, in order to provide a second variable G2. As schematically illustrated in FIG. 3, the evaluation unit 330 is adapted, according to embodiments described herein, to determine loads B on the tower 202 of the wind turbine 200 from the first variable G1 and the second variable G2 on the basis of a calculation model M which displays the behavior of the tower.

In this way, by means of the embodiments described herein of the device for determining loads on a wind turbine tower, an improved condition monitoring of the wind turbine tower can be provided.

According to further embodiments which may be combined with other embodiments described herein, the position sensor device of the device described herein can be adapted to carry out at least one method selected from the group consisting of: a GPS position detection method—in particular, per RTK GPS (Real-Time Kinematic GPS); a differential GPS position determination method; a camera-based position determination method; a radar-based position determination method; and a laser-based position determination method. Furthermore, the position sensor device can also be designed to use a stationary reference point for position determination.

FIG. 4 shows a wind turbine 200 with a device described herein for detecting loads according to embodiments described herein. The wind turbine 200 includes a tower 202 and a nacelle 203. Mounted on the nacelle 203 is a rotor 204. The rotor 204 includes a hub 205, to which the rotor blades 206 are attached. According to typical embodiments, the rotor 204 has at least two rotor blades—in particular, three rotor blades. During operation of the wind turbine, the rotor 204, i.e., the hub 205, rotates with the rotor blades 206 about an axis. A generator for power generation is driven thereby.

According to embodiments which may be combined with other embodiments described herein, a strain sensor 310, such as, for example, a fiber optic strain sensor 310 as shown in FIG. 5, is used in the wind turbine. Typically, the strain sensor 310 is provided on one or more rotor blades 206—in particular, in an outer radial region. As shown in FIG. 4, at least one strain sensor 310 is provided on a rotor blade. The strain sensor 310 is connected via a signal line 212, e.g., a light guide, to the evaluation unit 330 described herein. In this context, it should be noted that the use of fiber optic strain sensors in the rotor blades of wind turbines and for methods of monitoring wind turbines is particularly advantageous when a strain and/or a compression is measured in a direction perpendicular to the longitudinal axis of the light guide.

According to further embodiments, which can be combined with other embodiments described herein, at least one strain sensor is provided on each rotor blade, so that an individual strain or compression distribution can be measured separately in each rotor blade, and the corresponding bending moments can be determined. In particular, in accordance with the embodiments described herein, at least one fiber optic strain sensor is provided in each rotor blade.

According to some of the embodiments described herein, which can be combined with other embodiments, fiber optic strain sensors, in which a signal is optically transmitted via a light guide, allow a radial mounting position, hitherto regarded as unfavorable in practice, along a longitudinal direction of the rotor blade, since transmission by means of a light guide or an optical fiber involves a reduced risk of lightning damage. Fiber optic strain sensors may thus be provided, so as to allow mounting in a radially outer region of a rotor blade without increasing the risk of lightning damage.

FIG. 5 shows a simplified schematic representation of a fiber optic strain sensor 310 for measuring strains and/or compressions in accordance with the embodiments described herein. The strain sensor 310 includes a light guide 112 having a sensor element 111, e.g., a fiber Bragg grating, wherein the light guide 112 is clamped in a clamping device 305. The clamping device 305, in turn, includes a support structure, having a first fastener 301 for fastening the light guide 112 in a first position 401 and a second fastener 302 spaced from the first fastener 301 for fastening the light guide 112 in a second position 402, wherein the first and second positions 401, 402 have a first spacing in a longitudinal direction of the light guide 112. Furthermore, the fiber optic strain sensor can have an intermediate carrier 400 via which the strain sensor can be attached to a measurement object—for example, a rotor blade of a wind turbine. The sensor element 111 is typically sensitive to a fiber strain or a fiber compression (see arrow Δx in FIG. 5), so that optical radiation entering the light guide 112 with an altered wavelength profile is reflected from the sensor element 111, from which the strain can be determined—for example, with a corresponding evaluation and analysis unit.

It should be noted at this point that the aspects and embodiments described herein can be suitably combined with each other, and that individual aspects may be omitted where this is reasonable and possible within the bounds of professional competence. Modifications of and additions to the aspects described herein will be apparent to those skilled in the art.

1. Method for determining loads on a wind turbine tower, comprising:
Determining bending moments in at least one rotor blade of the wind turbine in order to provide a first variable, which identifies a first force acting on a nacelle of the wind turbine tower;
Determining a nacelle deflection in order to provide a second variable, which identifies a second force acting on the nacelle of the wind turbine tower;
Entering the first variable and the second variable into a calculation model that displays the behavior of the tower; and
Determining loads on the wind turbine tower by means of the calculation model.

2. Method according to claim 1, wherein, when determining the bending moments in the at least one rotor blade, a strain in the at least one rotor blade is measured using at least one strain sensor.

3. Method according to claim 2, wherein, when determining the bending moments in the at least one rotor blade, the strain in the at least one rotor blade is measured in two directions.

4. Method according to claim 2, wherein the at least one strain sensor is arranged in the at least one rotor blade.

5. Method according to claim 1, wherein, when determining the nacelle deflection, a position determination of the nacelle by means of a position sensor device that is adapted to carry out at least one method selected from the group consisting of: a GPS position determination; a differential GPS position determination method; a camera-based position determination method; a radar-based position determination method; and a laser-based position determination method.

6. Method according to claim 1, wherein, when determining the nacelle deflection, a stationary reference point is used.

7. Method according to claim 1, further comprising the determination of wind from the determined loads on the tower.

8. Method according to claim 1, wherein, when determining the loads on the tower by means of the calculation model, a Kalman filter is used, in order to increase accuracy in determining the loads on the tower.

9. Method according to claim 1, wherein, when determining the loads on the tower by means of the calculation model, wind turbine parameters are used.

10. Device adapted for determining loads on a wind turbine tower, comprising:
at least one strain sensor arranged and adapted for measuring a strain on at least one rotor blade of the wind turbine;
at least one position sensor device arranged and adapted for determining the position of a nacelle of the wind turbine tower; and
an evaluation unit connected to the at least one strain sensor for receiving a first signal from the at least one strain sensor and connected to the at least one position sensor device for receiving a second signal from the at least one position sensor device,
wherein the evaluation unit is adapted to determine, from the first signal, bending moments in the at least one rotor blade of the wind turbine, in order to provide a first variable,
wherein the evaluation unit is adapted to determine, from the second signal, a nacelle deflection, in order to provide a second variable, and
wherein the evaluation unit is adapted to determine loads on the wind turbine tower from the first and second variables by means of a calculation model that displays the behavior of the tower.

11. Device according to claim 10, wherein the position sensor device is adapted to carry out at least one method selected from the group consisting of: a GPS position determination method; a differential GPS position determination method; a camera-based position determination method; a radar-based position determination method; and a laser-based position determination method.
